(19) United States
(12) Patent Application Publication
(10) Pub. No.: US 2001/0036834 A1
(43) Pub. Date: Nov. 1, 2001

(54) Supporting fast intra-domain handoffs and paging in wireless cellular networks

(76) Inventors: Subir Das, Parsippany, NJ (US); Ashutosh Dutta, Lake Hiawatha, NJ (US); Archan Misra, Irvington, NY (US); Anthony J. McAuley, Glen Ridge, NJ (US); Sajal K. Das, Denton, TX (US)

Correspondence Address: Orville R. Cockings, Esq., Telcordia Technologies, Inc., Room 1G-112R, 445 South Street, Morristown, NJ, 07962, US

(21) Appl. No.: 09/798,468

(22) Filed: Mar. 2, 2001

Related U.S. Application Data
(60) Provisional application No. 60/186,910, filed on Mar. 3, 2000.

(51) Int. Cl. H04Q 7/20

(52) U.S. Cl. 455/458; 455/422

(57) ABSTRACT

A method and system for fast intra-domain handoffs. In accordance with the method a mobility agent performs a duration limited multicast of packets destined for a mobile node to a well-defined set of subnet agents that form a multi-cast group. The well defined set includes the neighboring subnet agents of the subnet agent currently serving the mobile node. Once the multicast group is established the mobility agent then tunnels packets destined for the mobile node to each member of the multicast group. The members of the multicast group, i.e., the current subnet agent and its neighboring agents, then buffer the packets destined for the mobile node for a limited. When the mobile node then requests an IP address on the new subnet it is moving to, i.e., a local care-of address, the corresponding subnet agent then transmits the packets destined for the mobile node to the mobile node. The limited duration multicast concept is further extended by defining a paging area and using a multicast within the paging area to reduce the frequency of intra-domain handoff updates.

### RELATED APPLICATIONS

The present application claims the benefit of U.S. Provisional Application No. 60/186,910 filed on Mar. 3, 2000 and entitled “Supporting Fast Intra-Domain Handoffs With TeleMIP In 3G Wireless Cellular Networks”.

### FIELD OF THE INVENTION

This invention relates generally to wireless networks, and more particularly, to a method and system for facilitating mobility of a node within a domain or network.

### BACKGROUND

The rapid growth of wireless networks and services, fueled by industry activity in the area of next generation mobile communication systems, has ushered in the era of ubiquitous computing. Lightweight portable computers, Internet Protocol-based (office and home) appliances, and the popularity of the Internet are providing strong incentives to service providers to support seamless user mobility. Realizing commercially viable Internet Protocol (IP) mobility support over the current cellular infrastructure, however, remains a challenge. In particular, for real-time multimedia (audio, video, and text) communications, user mobility poses several challenges.

Wireless access to telecommunication services has traditionally been provided through wide area cellular systems, which in turn are connected to the public telecommunication network backbones, such as the PSTN (Public Switched Telephone Network). It is expected that future wireless communications systems will be more heterogeneous and that every mobile user will be able to gain access to the Internet backbone by attaching his or her computer to a wireless access point. A telecommunication architecture that supports IP mobility will enable service providers to offer high-quality broadband multimedia services to mobile users in a cost effective way. Although, neither the Internet nor the telecommunications networks are currently designed to support high bandwidth, real-time multimedia services, a series of new technologies for third generation (3G) wireless systems are being developed to make this a reality. These technologies include IMT-2000 (International Mobile Telecommunications System), UMTS (Universal Mobile Telecommunication Systems), GPRS (General Packet Radio Service), EDGE (Enhance Data rate for GSM Evolution), CDMA-2000 (Code Division Multiple Access), and WCDMA (Wideband CDMA).

Mobility management in cellular networks is achieved in a different way than in IP-based networks. More precisely, mobility management enables telecommunication networks to locate mobile nodes, such as roaming wireless terminals for call delivery and to maintain connections as the nodes move into new service areas. Mobility management consists of two components, a location management and a handoff management. Location management enables the network to discover the current attachment point of the mobile user for call delivery. Handoff management enables the network to maintain connection to a mobile node as the mobile node continues to move and change its access point to the network.

Of particular import in the present invention is the handoff management component of mobility management. There are currently two ways in which a mobile node is handed off from one attachment point to another in the network, namely soft handoff and hard handoff. In a hard handoff a user may receive data from only one base station at any given time. In other words, there is a single wireless data transport path for a user at any given time and the path has to change when the user moves from one cell to another. This could cause data in transit, e.g., data that has been sent to the previous serving base station, to be lost during hard handoff therefore causing performance degradation.

In a soft handoff, the user seamlessly switches from one base station to the next without any perceptible degradation in service. During a soft handoff a mobile user communicates with multiple base stations simultaneously. Therefore, a user may be able to switch to a new base station without data loss. Soft handoff is the method of choice employed in the conventional CDMA wireless network. In addition, soft handoff must be supported in 3G wireless networks in order for multimedia applications to operate satisfactorily.

A significant prior art drawback with mobility management, in particular handoff management, is latency. In general, prior art schemes require a mobile node to update an agent in the mobile's home network, i.e., a home agent, each time the mobile node changes subnets and is assigned a new care-of address; by care-of address we refer to a temporary Internet Protocol (IP) address that is valid in the newly entered subnet. This is known as a location update. Every location update traverses the network all the way to the home agent. In some instances the location update can take a long time thereby introducing a large update latency in the location update process.

In U.S. patent applications Ser. No. ______ (Attorney Docket APP 1258) and ______ (Attorney Docket APP 1301), which are hereby incorporated by reference, we disclosed an architecture, methods, and systems that significantly reduced the handoff latency by not only providing for faster location updates, but also solved problems related to address space limitations and dynamic distribution of traffic loads. Though the methods, systems and architecture of U.S. patent applications Ser. No. ______ (Attorney Docket APP 1258) and ______ (Attorney Docket APP 1301) significantly reduce update latency and result in much faster support of intra-domain handoffs, thereby reducing handoff latency, we recognize that handoff latency may still be further improved.

Accordingly, an object of the present invention is a method and system to reduce handoff latency during intra-domain handoffs. In particular, and to illustrate the problem of handoff latency, consider a mobile node that is moving from a first subnet, subnet A, to a second subnet, subnet B. The mobile node must first obtain a valid IP address for subnet B from the entity responsible for assigning addresses in subnet B, e.g., a foreign agent. The obtained address must then be communicated by the mobile node to the entity responsible for tracking its location within the mobile node's home network, e.g., a home agent. Once this binding has reached the home agent, the home agent will make the corresponding update in its forwarding/binding table and transmit all subsequent packets for the mobile to its new destination in subnet B; by binding we mean the mapping of the old address to the new address. It is therefore obvious that packets will therefore be forwarded to the previous location of the mobile for some time period, e.g., time A, which corresponds to the delay in transmission of the location update from mobile node to its mobility agent.

### SUMMARY

In view of the above prior art limitations, it is an object of the present invention to provide a method and system that reduce update latency, thereby reducing handoff latency and minimize packet losses as a mobile node moves about the network.

In an aspect of our invention a method for enabling handoff of a mobile node begins with the mobile indicating to its current subnet agent that it may need to change subnets. The mobile may instantiate such a message upon hearing a neighboring base station. The subnet agent relays the message to the mobility agent for the mobile node. The mobility agent then establishes a multicast group comprising the neighbors of the current subnet agent and the subnet agent. Once the multicast group is established, the mobility agent then tunnels packets destined for the mobile node to each member of the multicast group. The members of the multicast group, i.e., the current subnet agent and its neighboring agents, then buffer the packets destined for the mobile node for a limited duration. When the mobile node then requests an IP address on the new subnet it is moving to, i.e., a local care-of address, the corresponding subnet agent then transmits the packets destined for the mobile node to the mobile node.

By using the method of this first aspect of our invention we are able to reduce handoff latency since the mobile node need not wait until after the mobility agent completes a location update, registration, and other mobility management functions with the new subnet agent. As such, the mobile node users does not suffer any degradation in service as a result of waiting for the mobility agent to perform a location update and other mobility management functions.

In a second aspect of our invention we establish a paging area having a paging area identifier. In accordance with this aspect of our invention a mobile node needs only to perform a location update each time it changes a paging area. This aspect of our invention reduces the frequency of intra-domain handoff updates.

### BRIEF DESCRIPTION OF THE DRAWINGS

FIG. 1 depicts an exemplary network wherein a mobile node is shown moving from one subnet to another subnet in accordance with a first aspect of our invention wherein a time limited multicast is used to enable fast handoffs;

FIG. 2 is a flow chart describing the method steps of the first aspect of our invention;

FIG. 3 depicts an exemplary network operating in accordance with a second aspect of our invention wherein paging is used to reduce the frequency of location updates; and

FIG. 4 is a flow chart describing the method steps of the second aspect of our invention.

### DETAILED DESCRIPTION

Broadly in accordance with an aspect our invention a limited multicasting of packets is used during the handoff process. By multicasting we do not specifically mean Internet Protocol (IP) multicasting. We use multicasting to mean that the same packet is forwarded to multiple recipients. Thus, packets destined for N recipients could indeed be forwarded using N separate unicast messages. Our solution or invention is therefore flexible and can be applied to different architectures. Further, in accordance with our invention group members to the multicast are not required to join and leave the group dynamically. Thus, while IP multicasting protocols, such as PIM-SM (Protocol Independent Multicast-Sparse Mode) or CBT (Core Based Trees) can be used as the multiple distribution mechanism, alternative protocols and technologies can also be used in cellular environments.

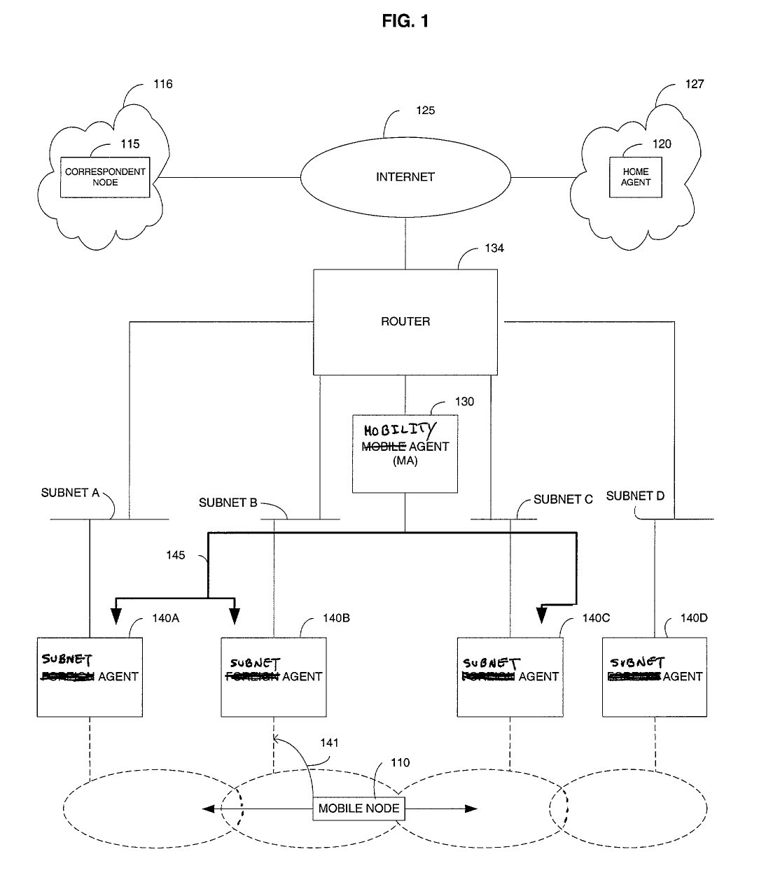

Turning to FIG. 1 there is depicted an exemplary network 100 wherein a mobile node 110 is shown moving from one subnet to another subnet. In particular, mobile node 110 is communicating with correspondent node 115. The correspondent node 115 may be a host or router with which the mobile communicates. In addition, the correspondent node may be mobile or stationary.

The correspondent node 115 resides in a correspondent network 116 and is connected to the mobile node's home agent 120 through a network, such as Internet 125. Home agent 120 resides in the mobile node's home network 127 wherein the mobile node 110 is given a long term IP address. Home agent 120 is responsible for maintaining the current location information for the mobile node 110 in addition to performing mobility management for mobile node 110 and other mobile nodes. For example, home agent 120 may include a table associating the home address of each mobile node with a global care-of-address received from the mobile node.

The home agent 120 is also connected to a mobility agent 130 through, for example, a router 134 which is connected to network 125. Router 134 routes packets to each of the subnets A, B, C, and D. Each of the subnets is connected to a subnet or foreign agent, 140A through 140D. The mobility agent 130 may provide a global-care-of address, namely the address of the mobility agent 130, to a mobile node and may intercept packets forwarded to the mobile node via the provided global care of address. The mobility agent 130 may be capable of handling mobile nodes located in one or more subnets A, B, C, and D. Each subnet agent 140 is responsible for assigning a local care of address while a mobile node is attached via that subnet agent's subnet. A subnet agent 140 may, for example, be a router, or a DHCP or DRCP server. In addition, a subnet agent is to be distinguished from a home agent in the sense that it is an agent on a network other than the home network of the mobile node. Thus, when a mobile enters a subnet network, the subnet agent is responsible for providing the mobile node with an additional address that is topologically consistent and valid within the subnet network. This additional address is referred to as the “care-of-address” and ensures that packets destined for the mobile node while in the subnet network actually get delivered to the mobile node.

In accordance with our invention, when the mobile node 110 decides that it is going to change its current subnet agent, for example, corresponding to a move from subnet B to subnet C, the mobile node sends a MovementImminent message 141 to its current subnet agent, subnet agent 140B. Note that the MovementImminent message can be very short and in most instances the mobile node will be able to transmit this message before it loses connectivity with the current subnet agent. The current subnet agent 140B then relays this message along with the identity of the mobile node 110 to the mobility agent 130 corresponding to the mobile node. The subnet agent maintains the identity (i.e., the IP address) of the mobility agent corresponding to the mobile node as a field in the subnet agent's table of supported mobile nodes. On reception of the MovementImminent message from subnet agent 140B, the mobility agent consults it tables and determines a multicast group that identifies the neighbors of subnet agent 140B. The mobility agent 130 then begins to encapsulate all subsequently arriving packets for the mobile node 110 and forwards the arriving packets, lines 145, to the multicast group members, e.g., subnet agents 140A, 140B, and 140C. This operation can be performed using a multicast distribution tree in IP environments. Since the set of neighboring subnets is well established, the membership of the multi-cast group is always stable. In accordance with our invention, the latencies associated with dynamic formation of the group are avoided, i.e., latencies associated with “Join” and “Leave” messages that are typical in prior art IP multicasting protocols.

Each member of the group, in this case subnet agents 140A and 140C as well as 140B, then buffers a limited number of these packets for the mobile node. When, for example, subnet agent 140C discovers that the mobile node 110 is requesting a local address on its subnet, it can immediately forward the cached packets to the mobile node even before the intra-domain location update process is completed. In accordance with our invention the buffered packets would be dropped from the buffer if the mobile node does not request a local address on the corresponding subnet within a certain time period. As such, our invention allows for design flexibility in that the size of the buffer can be optimized based on the location and number of subnet agents that allocated to a network.

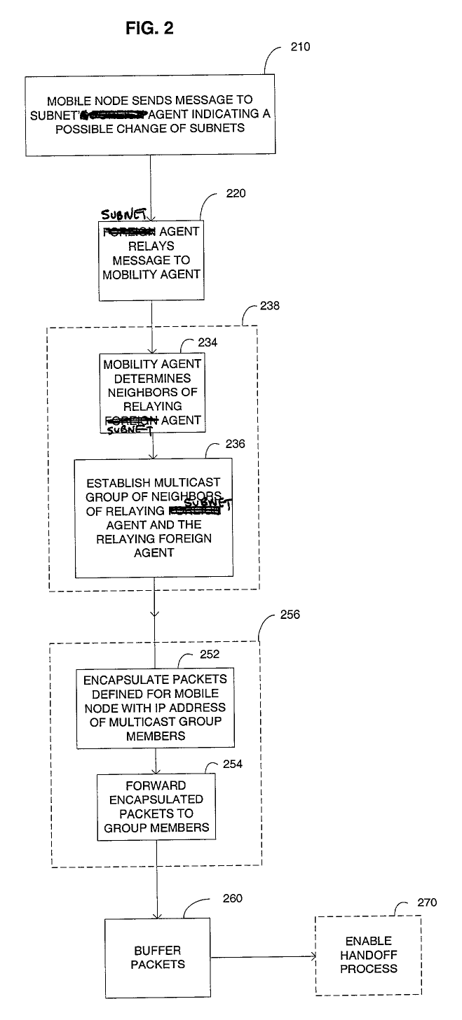

Turning now to FIG. 2 there is shown a flow chart describing the method steps of our invention. The method steps of FIG. 2 are independent of the network of FIG. 1 and may be implemented in any network that has a similar functional structure. Our method begins when a mobile node sends a message to the subnet agent of the subnet it is currently on indicating that the mobile node is about to change subnets or subnetworks, block 210. In accordance with the particular embodiment of FIG. 1, we describe this initial message as a MovementImminent message. The mobile node may send the MovementImminent message, for example, whenever it detects the presence of a base station within a neighboring subnet; base stations are not shown in FIG. 1, but those of ordinary skill in the art will know that the subnet agents communicate with the base stations that transmit messages over the air. Note too that by subnet agent we mean the entity within a subnet that is responsible for assigning a local care of address while a mobile node is attached via that subnet agent's subnet. Physically the subnet agent may be a router or a server.

Upon receipt of the message from the mobile node, the subnet agent or appropriate entity relays the message, along with the identity of the mobile node, to the mobility agent corresponding to the mobile node, block 220. By mobility agent we refer to any entity within a wireless cellular network that is responsible for managing the mobility of the mobile nodes within a particular domain.

Upon receipt of the message from the subnet agent, the mobility agent determines the neighbors of the subnet agents that relayed the message, block 234, and establishes a multicast group having the neighboring subnet agents and the relaying subnet agent, block 236. Although we have shown the steps of block 234 and 236 as separate steps, those of ordinary skill in the art will note that these steps may be performed as part of the same step, block 238.

With the multicast group established the mobility agent then encapsulates packets destined for the mobile, block 252, and forwards the encapsulated packets to subnet agents of the multicast group, block 254. By encapsulation we mean that each packet destined for the mobile is encapsulated with the IP address of each multicast member. Also, note that the steps of encapsulation and forwarding may be performed as one step, block 256. In addition, at this step the mobility agent may initiate a Multicast Duration timer. Note also, the steps of encapsulation and forwarding are similar to tunneling all the packets for the mobile node to the relevant multicast address.

When a neighboring subnet agent receives encapsulated packets via the multicast, it stores the packets, for example, in a First In First Out (FIFO) buffer, block 260, until the multicast duration expires or the mobile node issues local registration request for a local address.

When the mobile node then requests a local address on a subnet of a subnet agent, the subnet agent then enables the handoff process to begin, prior to the intra-domain location update process, by transmitting the packets destined for the mobile node to the mobile node, block 270.

By allowing for the selective storing and forwarding of packets, we reduce the requirement for extremely rapid Agent Advertisements from subnet agents as is required by the prior art. In the absence of our multicasting caching mechanism, the subnet agents would need to advertise their existence on the network at very high rates, since the latency of the location update process is directly affected by how soon the mobile node hears of the existence of the new subnet agent. Our method also relaxes the bounds on the intra-domain update latency for loss and sensitive applications, since they can receive uninterrupted communication even before the update process has completed.

We have determined that network entities, in particular subnet agents, operating in accordance with our invention are not required to have large sized buffers. For example, we have found that in an IP-based base station controller architecture, with a latency update process of 110 msec and a session data rate of 144 kilobits per second (vehicular data rate) the maximum buffer size is 1.98 kilobytes.

In addition, our invention offers distinct advantage over prior art schemes. For example, the schemes of Tan, et. al., “A Fast Mobility Scheme for Wireless Networks”, In Proc. Of Second ACM International Workshop on Wireless Mobile Multimedia (WOWMOM), ACM SIGMOBILE, August 1999, pp. 83-90 (hereinafter Tan) and Ghai, et. al., “An Architecture and Communication Protocol for Picocellular Networks”, IEEE Personal Communications, vol. 1, no. 3 1994, pp. 36-46 (hereinafter Ghai) assume that the DFA/supervisor always multicast all packets of a mobile node to the neighboring base stations cluster of pico-cells. This operation is necessary in Tan since, in the absence of any input from the mobile node, the DFA is always unaware of precisely when the mobile node is changing subnets or its point of attachment. Constant multicasting is necessary in Ghai since the supervisor is unaware of the mobile's exact location within a cluster of pico-cells. This results in un-necessary transmission and storage of packets for a mobile node, even when the mobile node is stationary. In contrast, in accordance with our invention, since the mobile node proactively informs the mobility agent through the subnet agent of its impending movement, the multicasting of packets is restricted to a very limited period.

Further, Tan identifies each mobile node with a unique multicast tree in that domain. This is not necessary, since the set of neighboring subnet agents of any subnet agent is independent of the identity of the mobile node. In contrast, our invention uses a single multicast group per set of neighboring subnet agents. Thus packets for all mobile nodes, which are located in the same subnet agent and have notified the mobility agent of impending movement, are tunneled over the single multicast tree.

Moreover, since the subnet agent will proactively begin forwarding any packets received by the multicast mechanism to the mobile node immediately after the mobile node has locally registered with the subnet agent, it should be clear that the packets will be received by the mobile node before it has successfully updated its location with the mobility agent. Our invention also guards against unauthorized access to the multicast packets, because the multicast decision is made by the mobility agent instead of the base station, as is done by Tan.

Although the use of multicasting for fast handoffs, in accordance with an aspect of our invention as described above, minimizes the loss of in-flight packets during an intra-domain handoff, it does not reduce the frequency of intra-domain location updates. Accordingly, a method that reduces intra-domain location updates is another aspect of our invention. In particular, the remaining problem is that in the absence of paging support, a mobile node must obtain a local care-of address and re-register with its mobility agent every time it changes its current subnet. This can lead to significant power wastage, especially in future fourth generation (4G) networks where a single device may maintain multiple simultaneous bindings with multiple radio technologies; by binding we mean that within each of these technologies the device is bound to a valid address within that radio technology domain or network.

Essentially, in this aspect of our invention, we extend the concept of providing multicast groups to a paging area. We group the subnet agents, in other words the subnets and associated base stations, into paging areas identified by unique identifiers. A mobile node in a passive/idle mode is then able to detect changes in its current paging area by listening to these unique identifiers in the subnet level advertisements, e.g. subnet agent advertisements. In fact, such IP-layer advertisements may optionally be combined with link layer beacons.

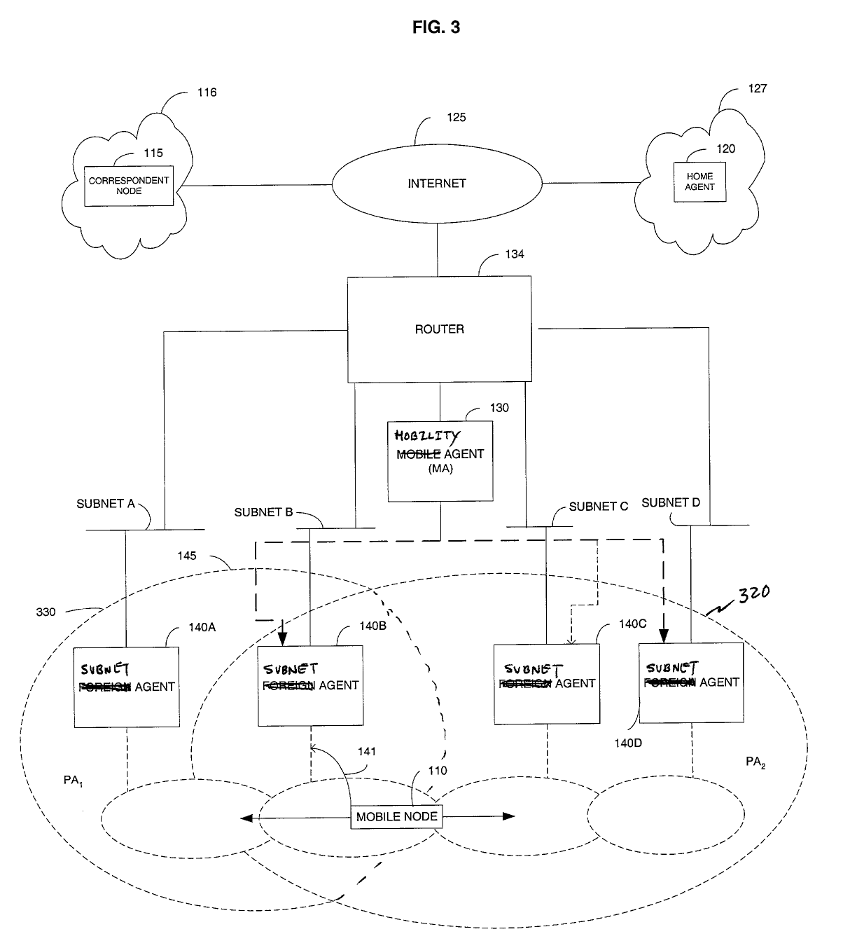

Turning now to FIG. 3 there is depicted an exemplary network operating in accordance with this aspect of our invention. In accordance with this aspect of our invention, subnets B, C, and D belong to the same paging area 320, while subnet A belongs to a different paging area 330. If the mobile node 110 is in an idle state in subnet B, then as long as it moves from subnet C to D, it does not detect a change in its current paging area 320 although it detects a change in its subnet attachment. Consequently, not only does the mobile node not update its mobility agent about its current local care-of address, it does not even bother to obtain a new local care of address. However, when it moves from to subnet A and realizes that it has changed to a new paging area, the mobile node obtains a new local care of address at subnet agent 140A and sends a location update to the mobility agent 130 indicating the new paging area.

When the mobility agent 130 receives packets for a mobile node that is currently registered, but which does not have a valid local care-of address assigned, the mobility agent multicasts a PageSolicitation packet to all the subnets associated with the mobile nodes current paging area (to subnet agents 140B, 140C, and 140D) and buffers the incoming packets. When the mobile node re-registers with the mobility agent, buffered packets are forwarded to the mobile node.

In accordance with this aspect of our invention, each paging area is identified by a unique domain-specific multicast address; a base station (not shown) belonging to a specific paging area must permanently subscribe to its corresponding paging area multicast group. Note that a base station can subscribe to multiple multicast groups and therefore can be associated with multiple paging areas.

In order for this aspect of our invention to function appropriately, a mobile node must actively inform its mobility agent when it switches from an active state to an idle state, thereby activating the paging functionality at the mobility agent. In the absence of active idle state notification, the mobile node would move to neighboring subnets without performing local registration, while the mobility agent would continue to (mistakenly) unicast arriving packets to the mobile node's last registered local care-of address. Moreover, when a mobile node changes its paging area in the idle state, it needs to inform the mobility agent only of its new paging area identifier but does not perform a local registration to obtain a local-care of address.

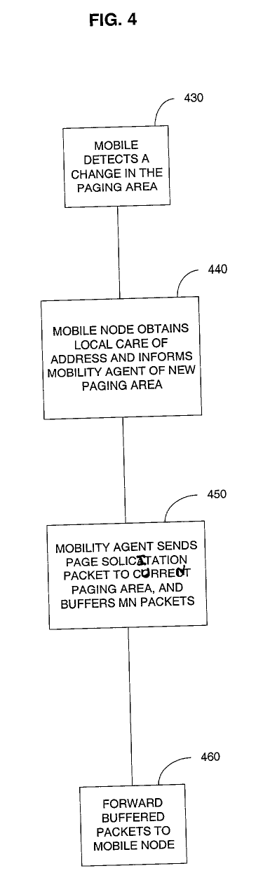

Turning to FIG. 4 there is depicted the method steps of the paging operation in accordance this aspect of our invention. Note, the method depends on the subnets being group into specific paging areas, each paging area being identified by a paging area identifier. In addition the mobile node should be in an idle state. By idle state we mean that the mobile node is not sending any messages, but is instead listening for messages/information being transmitted.

At block 430, a mobile node, already in an idle state, begins the process by detecting a message which indicates that it has changed paging area. As previously stated, the base stations within a paging area will transmit messages over the air that include the paging area identifier. In accordance with our invention when a mobile node detects a change in the paging area identifier it will know that it has changed paging areas.

Upon detecting a change in the paging area, the mobile node obtains a new local care of address from the appropriate subnet agent and sends a location update message that indicates the new paging area to the mobility agent, block 440.

When the mobility agent receives packets destined for a mobile node that is currently registered, but which does not have a valid local care-of address assigned, the mobility agent multicasts a PageSolicitation packet to all the subnets associated with the mobile nodes current paging area and buffers the incoming packets, block 450. By multicasting the PageSolicitation message the mobility agent is able to determine the location of the mobile node within the mobile node's current paging area.

When the mobile node re-registers with the mobility agent, buffered packets are forwarded to the mobile node, block 460.

The above description has been presented only to illustrate and describe the invention. It is not intended to be exhaustive or to limit the invention to any precise form disclosed. Many modifications and variations are possible in light of the above teaching. The applications described were chosen and described in order to best explain the principles of the invention and its practical application to enable others skilled in the art to best utilize the invention on various applications and with various modifications as are suited to the particular use contemplated.

We claim:

1. A method for intra-domain handoffs comprising the steps of:
sending a message from a mobile node to a first subnet agent;
relaying, by the first subnet agent, said sent message to a mobility agent;
multicasting, by the mobility agent, packets destined for the mobile node to all the neighboring subnet agents of the first subnet agent and the first subnet agent;
buffering at each of the neighboring subnet agents said multicasted packets; and
transmitting, by one of the neighboring subnet agents based on a request from the mobile node, said buffered packets to the mobile node so as to complete the intra-domain handoff.

2. The method of claim 1 wherein said step of multicasting includes establishing by said mobility agent a multicast group having the neighboring subnet agents as the group members.

3. The method of claim 2 wherein said step of multicasting includes encapsulating the packets destined for the mobile node with the Internet Protocol (IP) address of each of the multicast group members.

4. The method of claim 3 wherein said step of multicasting includes forwarding said encapsulated packets to the multicast group members.

5. The method of claim 1 wherein said sending step comprises said mobile node sending a message indicating imminent movement.

6. The method in accordance with claim 1 further comprising terminating said buffering on expiration of a multicast duration timeout period.

7. The method in accordance with claim 1 wherein said subnet agents are grouped into paging areas identified by unique identifiers and further comprising the step of the mobile node detecting a change in its current paging area by listening to a transmitted paging identifier.

8. A method for paging a mobile node in a wireless cellular network, the network having subnet agents that are grouped in paging areas identified by unique identifiers, mobile nodes that communicate with the subnet agents, and a mobility agent that is also able to communicate with the subnet agents and the mobile nodes, said method comprising the steps of:
detecting, by a mobile node, a new paging area;
obtaining, by the mobile node, a local care of address;
informing, by the mobile node, the mobility agent of the new paging area;
sending, by the mobility agent, a page solicitation message to all the subnets associated with the mobile node current paging area;
buffering packets destined for the mobile node at the mobility agent; and
forwarding said buffered packets to the mobile node when the mobile node reregisters with the mobility agent.
